(19) United States
(12) Patent Application Publication
(10) Pub. No.: US 2005/0242727 A1
(43) Pub. Date: Nov. 3, 2005

(54) Plasma display panel

(76) Inventors: Min Hur, Suwon-si (KR); Young-Do Choi, Suwon-si (KR)

Correspondence Address: MCGUIREWOODS, LLP, 1750 TYSONS BLVD, SUITE 1800, MCLEAN, VA, 22102, US

(21) Appl. No.: 11/116,275

(22) Filed: Apr. 28, 2005

(30) Foreign Application Priority Data
Apr. 29, 2004 (KR) 10-2004-0029889

(51) Int. Cl. H01J 17/49

(52) U.S. Cl. 313/582

(57) ABSTRACT

A plasma display panel including a first and a second substrate facing each other, address electrodes formed on the second substrate, barrier ribs arranged between the first substrate and the second substrate to partition discharge cells, and scan and sustain electrodes formed on the first substrate in a direction crossing the address electrodes such that the scan and sustain electrodes correspond to respective discharge cells. Protrusion electrodes are formed at the sustain and the scan electrodes such that the protrusion electrodes extend to the inside of the discharge cell while facing each other. Concave portions are internally formed at the surfaces of the protrusion electrodes facing each other, and extensions are formed at the peripheries of the surfaces of the protrusion electrodes. The shortest distance between the protrusion electrodes is made at the extensions, and the extensions have inclined end portions.

### CROSS REFERENCE TO RELATED APPLICATION

This application claims priority to and the benefit of Korean Patent Application No. 10-2004-0029889, filed on Apr. 29, 2004, which is hereby incorporated by reference for all purposes as if fully set forth herein.

### BACKGROUND OF THE INVENTION

1. Field of the Invention

The present invention relates to a plasma display panel, and in particular, to a plasma display panel with an improved electrode structure that may enable a lower discharge voltage and enhanced discharge efficiency.

2. Discussion of the Background

Generally, a triode-structured plasma display panel (PDP) has sustain and scan electrodes arranged in parallel to each other, and address electrodes arranged substantially perpendicular thereto, thereby forming discharge cells. The PDP's electrodes may have an MxN is matrix pattern where M address electrodes may be arranged in the column direction, and the N sustain and scan electrodes may be alternately arranged in the row direction.

With a PDP having the above electrode structure, individual sub-fields may comprise a reset period, an address period, and a sustain period.

The reset period erases a wall charge state of a previous sustain discharge and sets up wall charges to stably perform the following address period. Reset voltages are applied to the electrodes during the reset period.

In the address period, discharge cells that are to be turned on are selected, and wall charges are generated at the turned-on discharge cells (the addressed discharge cells). Address voltages are applied to the electrodes during the address period.

In the sustain period, alternately applying sustain voltages to the scan and sustain electrodes generates a sustain discharge in the addressed cells to display images.

However, with the triode-structured PDP, the scan and sustain electrodes are typically arranged at both ends of the discharge cells, and images are displayed through surface discharge. Hence, the inter-electrode gap may be wide, which increases the discharge firing voltage.

Japanese Patent Laid-open Publication No. 2000-082407 discloses an electrode structure where an electrode protrudes toward the center of the discharge cell in the shape of a capital letter “T.” In that structure, the electrode area increases at the center of the discharge cell, which lowers the firing voltage. However, the main discharge may be confined to the interface area between electrodes, which deteriorates discharge efficiency.

### SUMMARY OF THE INVENTION

The present invention provides a PDP that may have high discharge efficiency with a decreased discharge voltage.

Additional features of the invention will be set forth in the description which follows, and in part will be apparent from the description, or may be learned by practice of the invention.

The present invention discloses a PDP including a first substrate and a second substrate facing each other, address electrodes formed on the second substrate, barrier ribs arranged between the first substrate and the second substrate to partition discharge cells, and scan electrodes and sustain electrodes formed on the first substrate in a direction crossing the address electrodes such that they correspond to the respective discharge cells. Protrusion electrodes are formed at the sustain electrodes and the scan electrodes such that they extend toward a center of a discharge cell while facing each other. Concave portions are formed at surfaces of the protrusion electrodes facing each other, and extensions are formed at peripheries of the surfaces of the protrusion electrodes facing each other. The shortest distance between facing protrusion electrodes is at the extensions, and the extensions have inclined end portions.

The present invention also discloses a PDP including a first substrate and a second substrate facing each other, address electrodes formed on the second substrate, barrier ribs arranged between the first substrate and the second substrate to partition discharge cells, and first electrodes and second electrodes formed on the first substrate in a direction crossing the address electrodes such that they correspond to the respective discharge cells. Protrusion electrodes are formed at the first electrodes and the second electrodes extending toward a center of a discharge cell while facing each other. The protrusion electrode of a first electrode has a concave portion at a surface that faces a second electrode, and the protrusion electrode of the second electrode has a convex portion with angled edges at a surface that faces the first electrode. The shortest distance between the protrusion electrodes of the first and second electrodes is at the angled edges.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a partial exploded perspective view showing a PDP according to an exemplary embodiment of the present invention.

FIG. 2 is a cross-sectional view taken along line A-A of FIG. 1.

FIG. 3, FIG. 4, FIG. 5 and FIG. 6 are plan views showing electrode arrangements of PDPs according to exemplary embodiments of the present invention.

### DETAILED DESCRIPTION OF THE ILLUSTRATED EMBODIMENTS

The present invention will be described more fully hereinafter with reference to the accompanying drawings showing exemplary embodiments of the present invention.

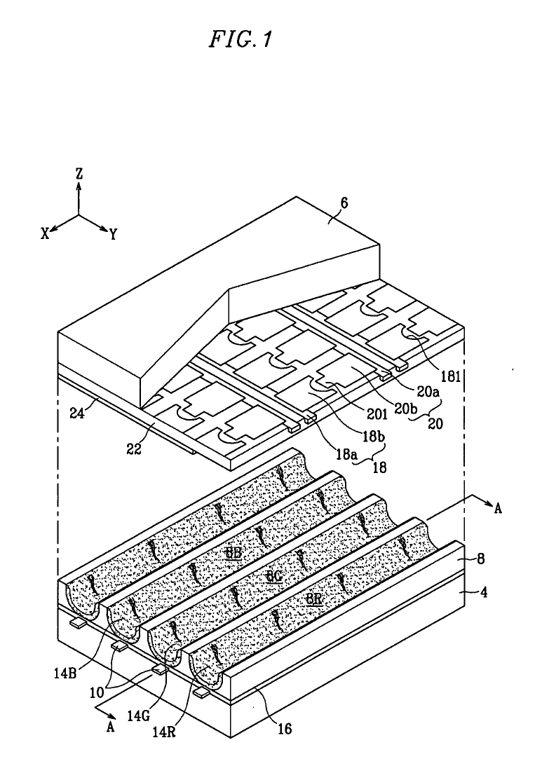

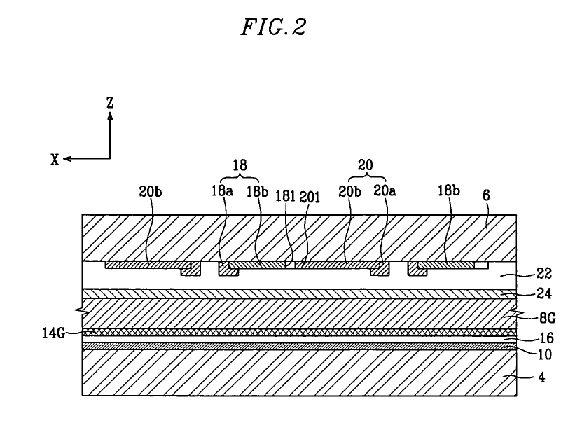

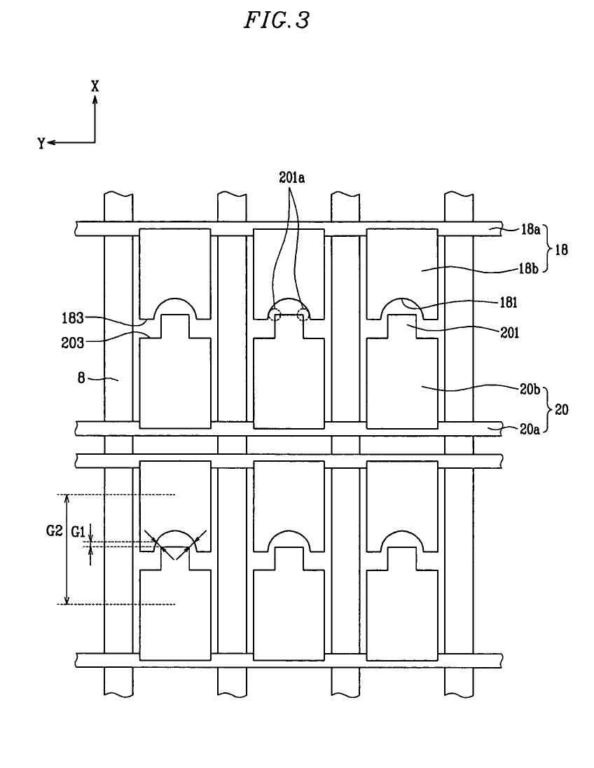

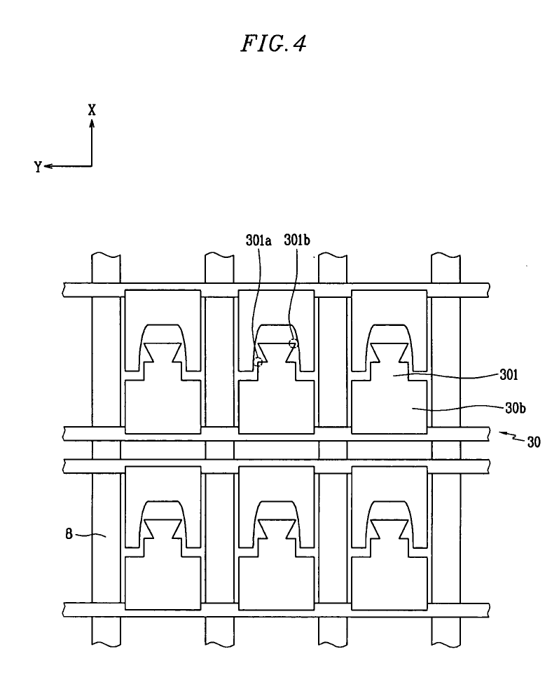

FIG. 1 is a partial exploded perspective view showing a PDP according to an exemplary embodiment of the present invention, and FIG. 2 is a cross-sectional view taken along line A-A of FIG. 1.

Referring to FIG. 1 and FIG. 2, the PDP may include a first substrate 6 and a second substrate 4 spaced apart from each other by a predetermined distance. Red (R), green (G) and blue (B) discharge cells 8R, 8G, and 8B are partitioned by barrier ribs 8 and disposed between the first substrate 6 and the second substrate 4.

Address electrodes 10 may be formed on the inner surface of the second substrate 4 in a direction of the X axis of the drawing, and a dielectric layer 16 may cover the address electrodes 10. The address electrodes 10 may be arranged parallel to each other along centers of the discharge cells 8R, 8G, and 8B in the width direction thereof (in the direction of the Y axis of the drawing) with a predetermined distance therebetween.

The barrier ribs 8 may be formed on the dielectric layer 16 to partition the discharge cells 8R, 8G, and 8B, which are distinguished from each other by the red, green, and blue phosphor layers 14R, 14G, and 14B coated therein.

Red, green, and blue phosphors may be coated within the discharge cells 8R, 8G, and 8B to form phosphor layers 14R, 14G, and 14B. Plasma discharge generates vacuum ultraviolet rays that excite the phosphor layers 14R, 14G, and 14B to emit light, thereby radiating respectively colored visible rays from the discharge cells 8R, 8G, and 8B.

Pairs of display electrodes including a sustain electrode 18 and a scan electrode may be arranged on the first substrate 6 in the direction crossing the address electrodes 10 (in the direction of the Y axis of the drawing) with a predetermined distance therebetween. Each display electrode pair 18 and 20 corresponds to a discharge cell.

The sustain and scan electrodes 18 and 20 may be formed with transparent electrodes 18b and 20b, which perform the surface discharge, and bus electrodes 18a and 20a, which enhance the conductivity of the transparent electrodes 18b and 20b. The bus electrodes Is 18a and 20a are arranged substantially perpendicular to the address electrodes 10 (in the direction of the Y axis of the drawing) while being spaced apart from each other by a predetermined distance.

The transparent electrodes 18b and 20b protrude toward the centers of the discharge cells while partially contacting the bus electrodes 18a and 20a to thereby form protrusion electrodes. Accordingly, the transparent electrodes 18b and 20b face each other around the centers of the discharge cells. A dielectric layer 22 may cover the sustain and scan electrodes 18 and 20, and a protective layer 24, which may be a magnesium oxide layer, may cover the dielectric layer 22.

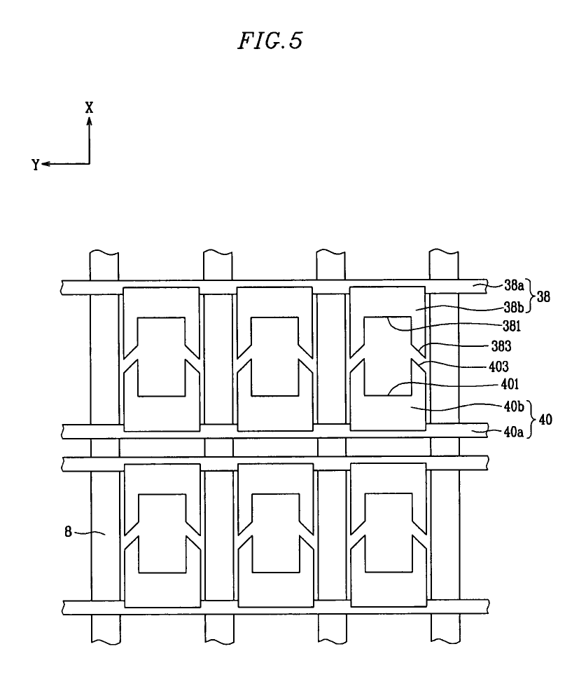

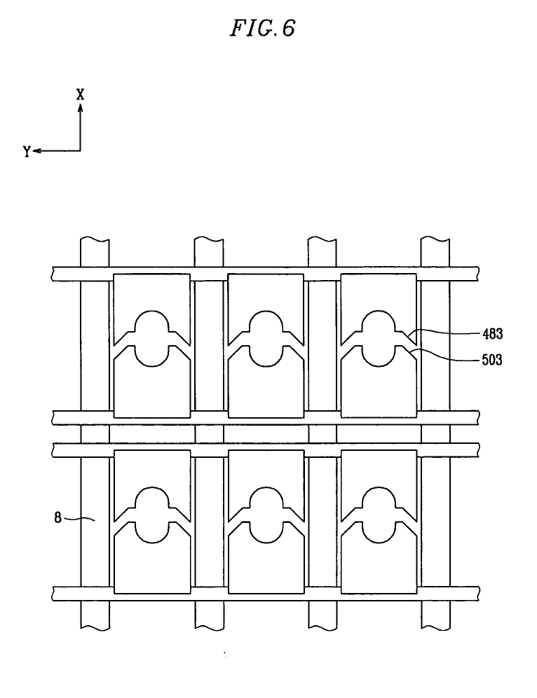

An electrode structure with a lowered discharge firing voltage according to the first exemplary embodiment of the present invention will now be explained with reference to FIG. 3.

With the surface discharge structure, the inter-electrode discharge begins from the electrode interface and gradually diffuses to the inside portions of the electrodes. After the discharge begins, the charges have high energy due to the sheath phenomenon, and the energy for exciting the discharge gas is lower than the high energy of the charges. Accordingly, with a PDP where the glow discharge is made as the main discharge, the “positive column” may more effectively excite the discharge gas. The longer the discharge path is, the more the discharge efficiency may increase.

Hence, with the electrode structure according to an embodiment of the present invention, the protrusion electrodes 18b and 20b extend toward the centers of the discharge cells while facing each other, thereby reducing the inter-electrode discharge path.

Furthermore, a concave portion 181, which is concave toward the bus electrode 18a, may be formed at the surface 183 of the protrusion electrode 18b that faces the protrusion electrode 20b. Here, the sustain electrode 18 is not discharged during the address period. The concave portion 181 may be angled or rounded.

A convex portion 201, which corresponds to the concave portion 181, may be formed at the surface 203 of the protrusion electrode 20b facing the protrusion electrode 18b. As FIG. 3 shows, the convex portion 201 may extend inside the concave portion 181 to decrease the distance between the protrusion electrodes 18b and 20b. Further, the convex portion 201 may have angled edges 201a (i.e. not rounded)that minimize the distance between the protrusion electrodes 18b and 20b. Two or more edges 201a may be formed at the convex portion 201 while facing the concave portion 181, and the edges 201a may be symmetrically placed left and right with respect to the address electrodes 10, which are arranged along the X axis of the drawing.

Accordingly, the discharge may be initiated around the edges 201a where the electric field's highest intensity is exerted. As the discharge made at the edges 201a is a corona discharge, the discharge may be locally made. Therefore, as shown in FIG. 4 according to a variant of the present embodiment, the scan electrode 30 may include a protrusion electrode 30b having a convex portion 301 with four or more edges 301a and 301b that are symmetrically placed left and right with respect to the address electrodes 10 (with respect to the X axis of the drawing), thereby inducing the glow discharge.

Referring back to FIG. 3, as the area of the convex portion 201 is smaller than the area of the protrusion electrode 20b, the short gap (G1) discharge initiated from the convex portion 201 may shift to the long gap discharge (G2) made between centers of the electrodes 18b and 20b.

The scan electrode 20 may have a larger area than the sustain electrode 18. Hence, the capacitance of the scan electrode 20, which is proportional to its area, increases, thereby lowering the address discharge firing voltage.

A PDP according to a second exemplary embodiment of the present invention will now be explained with reference to FIG. 5.

With the electrode structure according to the second exemplary embodiment of the present invention, the protrusion electrodes 38b and 40b, which partially contact the bus electrodes 38a and 40a, extend toward the centers of the discharge cells while facing each other, thereby reducing the inter-electrode discharge path.

As capacitance is proportional to area, a high intensity discharge may be made with an increased area. Accordingly, when the long gap discharge is made as the main discharge, with the increased short gap discharge area, the high intensity discharge is made, and as a result the surface charges may be deposited at the front ends of the electrodes, thereby reducing the electric field. Consequently, the high intensity discharge of the last half of the discharge to be followed by the long gap discharge may be prevented.

In this connection, with the structure according to the present embodiment, concave portions 381 and 401, which are directed toward the bus electrodes 38a and 40a, respectively, may be formed at the front end surfaces of the protrusion electrodes 38b and 40b where the long gap discharge is made. The concave portions 381 and 401 may be angled or rounded.

As the concave portions 381 and 401 are formed at centers of the protrusion electrodes 38b and 40b, extensions 383 and 403 may be formed at the relatively protruded peripheral portions of the protrusion electrodes 38b and 40b facing each other. Consequently, the shortest distance between the electrodes 38 and 40 occurs at their extensions 383 and 403, and the highest intensity of electric field being in inverse proportion to that distance is exerted. Accordingly, a short gap discharge may be made around the extensions 383 and 403.

As the electrodes 38 and 40 may have a small interface area at the extensions 383 and 403, the discharge voltage there at may be high. Therefore, in this embodiment, the surfaces of the extensions 383 and 403 facing each other may be inclined with a rectilinear shape or a rounded shape. Further, the inclination of the extensions 383 and 403 is made such that they have corresponding shapes. Additionally, as shown in FIG. 6 according to a variant of the present embodiment, the inclination direction may be varied at one or more locations to enlarge the interface area between the extensions 483 and 503.

As described above, the discharge may be stably initiated with a low discharge firing voltage, and a larger amount of Xe may be used in the discharge gas. Furthermore, a greater area of the discharge cells may be used, and the luminescence efficiency may increase. Also, the PDP may be driven at high speed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A plasma display panel, (PDP) comprising:
a first substrate and a second substrate facing each other;
address electrodes formed on the second substrate;
barrier ribs arranged between the first substrate and the second substrate to partition discharge cells; and
scan electrodes and sustain electrodes formed on the first substrate in a direction crossing the address electrodes such that the scan electrodes and the sustain electrodes correspond to respective discharge cells,
wherein protrusion electrodes formed at the sustain electrodes and the scan electrodes extend toward a center of a discharge cell while facing each other,
wherein concave portions are formed at surfaces of the protrusion electrodes facing each other, extensions are formed at peripheries of the surfaces of the protrusion electrodes facing each other, and a shortest distance between facing protrusion electrodes is at the extensions, the extensions having inclined end portions.

2. The PDP of claim 1, wherein extensions are formed at both sides of the concave portions.

3. The PDP of claim 1, wherein the inclined end portions of the extensions of the protrusion electrodes facing each other have corresponding shapes.

4. The PDP of claim 1, wherein the extensions are inclined with a rectilinear shape or a rounded shape.

5. The PDP of claim 1, wherein the extensions vary in a direction of inclination at at least one location.

6. The PDP of claim 1, wherein the concave portions are rounded or angled.

7. The PDP of claim 1, wherein the concave portions are formed at a centerline of the discharge cell.

8. The PDP of claim 1, wherein the sustain electrodes and the scan electrodes comprise transparent electrodes that form the protrusion electrodes and that are coupled with bus electrodes.

9. A plasma display panel (PDP), comprising:
a first substrate and a second substrate facing each other;
address electrodes formed on the second substrate;
barrier ribs arranged between the first substrate and the second substrate to partition discharge cells; and
first electrodes and second electrodes formed on the first substrate in a direction crossing the address electrodes such that the first electrodes and the second electrodes correspond to respective discharge cells,
wherein protrusion electrodes formed at the first electrodes and the second electrodes extend toward a center of a discharge cell while facing each other,
wherein the protrusion electrode of a first electrode has a concave portion at a surface that faces a second electrode, the protrusion electrode of the second electrode has a convex portion with angled edges at a surface that faces the first electrode, and a shortest distance between the protrusion electrodes of the first electrode and the second electrode is at the angled edges.

10. The PDP of claim 9, wherein the convex portion extends within the concave portion.

11. The PDP of claim 10, wherein two or more angled edges are formed at the convex portion facing the concave portion.

12. The PDP of claim 11, wherein the angled edges of the convex portion are symmetrically placed left and right with respect to the address electrodes.

13. The PDP of claim 9, wherein an address discharge occurs in the discharge cell between an address electrode and one electrode of the first electrode and the second electrode that has a larger area than the other.

14. The PDP of claim 13, wherein the address discharge occurs between the address electrode and the second electrode.

15. The PDP of claim 9, wherein the concave portion is formed at a centerline of the discharge cell.

16. The PDP of claim 12, wherein the concave portion is formed at a centerline of the discharge cell.

17. The PDP of claim 9, wherein the concave portion is rounded or angled.

18. The PDP of claim 9, wherein the first electrodes and the second electrodes comprise transparent electrodes that form the protrusion electrodes and that are coupled with bus electrodes.
